(19) United States
(12) Patent Application Publication
(10) Pub. No.: US 2007/0112597 A1
(43) Pub. Date: May 17, 2007

(54) MONETIZING LARGE-SCALE INFORMATION COLLECTION AND MINING

(75) Inventors: David E. Heckerman, Bellevue, WA (US); Craig J. Mundie, Redmond, WA (US); Nebojsa Jojic, Redmond, WA (US); Randy J. Hinrichs, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/556,069

(22) Filed: Nov. 2, 2006

Related U.S. Application Data
(63) Continuation-in-part of application No. 11/266,974, filed on Nov. 4, 2005.

(51) Int. Cl. G06Q 10/00; G07G 1/14; G06F 7/00

(52) U.S. Cl. 705/2; 707/101; 705/14

(57) ABSTRACT

The subject matter described herein facilitates monetizing a database of unclean health-related data collected on a large-scale and pertaining to a non-selected population. At least one pattern can be automatically ascertained from the unclean health-related data at least in part by applying a statistical technique, a data mining technique and/or a machine-learning technique to the database. The use of the database can be tracked and fees determined accordingly.

### CROSS-REFERENCE TO RELATED APPLICATIONS

This application is a Continuation-in Part of U.S. patent application Ser. No. 11/266,974, entitled “LARGE-SCALE INFORMATION COLLECTION AND MINING,” filed Nov. 4, 2005. This application is also related to U.S. patent application Ser. No. ______ entitled, “TOOLS FOR HEALTH AND WELLNESS”, filed Nov. 2, 2006 (Atty. Docket No. MS317798.01/MSFTP1475US). The entireties of the aforementioned applications are incorporated herein by reference.

### BACKGROUND

Many industries benefit from drawing statistically-valid conclusions from data. For instance, health-care providers increasingly base diagnostic and treatment decisions as well as wellness recommendations on the current best evidence (i.e., increasingly they practice evidence-based medicine). Preferably, clinicians rely on the “gold standard” of evidence when making medical decisions—randomized, controlled, double-blind clinical trials. If clean data from a randomized, controlled, double-blind clinical trial relating to a patient's condition is not available, clinicians often rely on other sources of clean data that best adhere to the well-established principles of the scientific method. Examples of clean data include randomized, controlled, double-blind clinical trials, controlled but not randomized clinical trials, uncontrolled clinical trials, unblinded clinical trials, and other types of studies involving researcher selected populations. However, clean data is expensive and time-consuming to obtain and, depending on the patient's condition, may not be available at all.

By way of another example, collecting and aggregating drug safety information is an important but challenging task. To address the potential for harmful drug effects, many countries establish government agencies to approve a pharmaceutical or medical device product before it can be sold to the public. These agencies usually require proof of efficacy and of an acceptable safety profile before the pharmaceuticals and medical devices are approved for sale. Typically the proof is obtained by conducting clinical trials on selected populations (clean data). These trials usually take many months and are quite expensive to conduct. In addition, some countries have post-market surveillance mechanisms in place, such as mandatory and voluntary adverse event reporting. However, delays inherent in the current systems have resulted in medications and devices with unacceptable risks remaining on the market during the time the data is being collected and aggregated.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Although it is desirable to draw conclusions from clean data, collecting clean data is complex, time-consuming and costly to perform. Since a larger sample size helps to overcome the effects that a lack of a selected population and/or a lack of controls have on statistical significance, analyzing large amounts of unclean or not necessarily clean data (e.g., data from a non-selected, unselected or self-selected population) can yield valuable information. Unclean data can be of any type including but not limited to health-related information. The data can be provided explicitly or automatically culled from existing information (e.g., frequency of prescription refills as an indication of whether a patient is taking their medication as prescribed). Although data so obtained may be noisy, machine-learning/data-mining algorithms can be used to “see” through this noise to discover useful patterns. The mining process can be directed toward, for example, elucidating new drug side effects and/or interactions among drugs and/or diseases.

This large amount of unclean data and the observations culled therefrom have many valuable applications. For instance, the conclusions, discovered knowledge and/or the raw data can be forwarded to health-related agencies and/or private companies (e.g., pharmaceutical, biotechnology, medical device, etc.) or these entities otherwise can be given access to the data (e.g., an interface to access the database) for a fee. By way of example, the fee can be applied on a per use basis or a subscription service can be provided (i.e., payment for unlimited or limited access to the database for a period of time).

Moreover, information about those individuals contributing to the database can be maintained and used to provide the individuals with information and/or services (i.e., a diagnosis, wellness advice, facilitating medical appointments, etc.). In order to protect an individual's privacy, information about an individual can be stored anonymously, for instance by associating a subscriber number with a user password or by employing any other mechanisms to protect confidential information. Additionally or alternatively, a user can be asked to consent to the dissemination of the user's information to third parties.

By way of example, the database can facilitate providing services such as self-diagnosis (e.g., health and wellness, etc.), self treatment advice and/or guidance regarding seeking and identifying professional assistance (e.g., referrals, facilitating medical appointments, etc.). The guidance can be based on a variety of factors, such as the complexity of the diagnosis/problem/condition, the nature of the diagnosis/problem/condition, the location of the individual and/or the budget of the individual. By way of another example, the database can facilitate personalizing healthcare. For instance, as the cost of gene sequencing drops, it is expected that people routinely will have their genes sequenced. This patient-specific genetic data can be correlated with an individual's health history and/or health-related behaviors to, for example, identify personalized diagnostic procedures and personalized therapies for medical conditions.

These services can be monetized by charging a fee for the service to the user, a referral fee to a health-care provider and/or charging for advertisements provided to the user while using the service. Additionally or alternatively, information about the individual can be sent to third parties for a fee provided that the individual has given his/her consent or provided that sending the information otherwise complies with applicable laws.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of a system that facilitates health-information reporting.

FIG. 2 is a block diagram of another example of a system that facilitates health-information reporting.

FIG. 3 is a block diagram of another example of a system that facilitates health-information reporting.

FIG. 4 is a block diagram of yet another example of a system that facilitates health-information reporting.

FIG. 5 is an illustration of one example of an interface for reporting health-related information.

FIG. 6 is an illustration of another example of an interface for reporting health-related information.

FIG. 7 is a flowchart representing one example of a method of extracting health observations.

FIG. 8 is a flowchart representing another example of a method of extracting health observations.

FIG. 9 is a block diagram of one example of a system to facilitate large-scale medical data analysis.

FIG. 10 is a block diagram representing one example of a system that facilitates monitoring a database of unclean health-related data collected on a large-scale.

FIG. 11 is a block diagram representing another example of a system that facilitates monitoring a database of unclean health-related data collected on a large-scale.

FIG. 12 is a block diagram representing yet another example of a system that facilitates monitoring a database of unclean health-related data collected on a large-scale.

FIG. 13 is a flowchart representing one example of a method of monetizing information obtained on a macro-scale.

FIG. 14 is a flowchart representing another example of a method of monetizing information obtained on a macro-scale.

FIG. 15 is a flowchart representing yet another example of a method of monetizing information obtained on a macro-scale.

FIG. 16 is a block diagram representing one example of an online system to facilitate monetizing unclean medical data.

### DETAILED DESCRIPTION

The subject matter described herein facilitates collecting and mining very large amounts of unclean or not necessarily clean data and optionally storing the information in a database. The collected and/or mined data can be utilized to generate revenue. For instance, the conclusions, discovered knowledge and/or the raw data can be forwarded to health-related agencies and/or private companies (e.g., pharmaceutical, biotechnology, medical device, etc.) or these entities otherwise can be given access to the data (e.g., an interface to access the database) for a fee. By way of example, the fee can be applied on a per use basis or a subscription service can be provided (e.g., payment for unlimited or limited access to the database for a period of time).

Because the data can be associated with a particular user, a useful by-product of the data collection process is the facilitation of providing health and/or wellness advice/services to a user and the monetization of such services. By way of example, a user can open an interactive session with a tool for accessing the database. The tool can provide an interface with the database via text, audio and/or video. For instance, a dialog can be started with the user that leads the user through a series of questions to facilitate converging on an accurate diagnosis, treatment option or referral. The interface can optionally receive real-time data (manually input and/or by sensors) such as temperature, location, weight, facial expression, etc. Upon reaching a conclusion having a predetermined level of confidence, the tool can provide the user with a diagnosis, including background information on the diagnosis, and/or treatment options and health-care referrals.

Users can be charged a fee for using the tool, or the tool otherwise can be monetized. For example, users can be provided full privacy in connection with use of the tool; however they can be incentivized to expose some of their personal information in exchange for more granular diagnoses, free treatments, discounts, etc. By way of another example, health insurance companies can provide businesses with group discounts for having employees use the tool before making an appointment with a doctor and the health insurance companies can pay a fee to the database owner for this service. Emergency medical teams can use portable versions of the tool to enter patient information at the site of the emergency in order to have a preliminary diagnosis sent to the emergency room (ER) prior to a patient's arrival at the ER or to inform emergency personnel of available interventions. A fee can be charged to the patient's insurance company for such a service. Additionally or alternatively, dynamic advertisements can be generated as a function of a user inquiry, a user's profile, or an inferred diagnosis/treatment/referral, etc., and delivered to a user while using the tool. Advertising fees can be charged/collected accordingly. By way of example, drug companies can offer comprehensive plug-ins to the tool in exchange for preferred ad space. By way of another example, advertisers can bid on keywords or key phrases and when these keywords/phrases are entered by a user as part of a query, the highest bidder's ad can be presented to the user. Additionally or alternatively, the tool can infer a keyword/phrase from a user's entry. Examples of keywords/phrases include but are not limited to symptoms, medications, diseases/medical conditions and treatments.

The tool can be used to facilitate scheduling medical appointments, including prioritizing treatments, and can enable distributed/virtual medical offices made up of doctors located at disparate locations. In this embodiment, patient data and diagnostic collaboration regarding the data can be exchanged over the web. By way of example, certain treatments amenable to digital image based diagnosis (e.g., cytology, scans, radiology, etc.) can be provided to physicians located elsewhere and the data can be sent in real time or later for evaluation. Additionally or alternatively, the tool can provide for the auctioning of medical contracts to allow groups of doctors to bid for bulk jobs (e.g., a group of doctors can bid to review x-rays for a hospital in another city).

The data received by the tool can be of any type including but not limited to health-related information. In one embodiment, health-related information can be obtained from a wide variety of sources including but not limited to directly from patients via a computerized service, such as a web site using a web form for entering information. The data can be correlated with information from a variety of different sources and/or systems to facilitate drawing conclusions relating to the patient's health. Any source having pertinent information can subscribe to the web service to provide information. Such sources of information include insurers, providers (e.g., doctors, nurses, hospitals, nursing homes, etc.) and devices (e.g., pacemakers, smart scale, etc.).

To encourage user participation, incentives can be provided and/or the data can be anonymized to address patient privacy concerns. For example, a third-party payer can require a subscriber to file a report as a condition of renewing a prescription for medication or to qualify for a lower co-payment/rate. In another embodiment, coupons for discounts on goods and/or services can be offered. With regard to anonymity, for example, no identifying information may be required (such as name and address) and instead an anonymous ID (e.g., passport ID) can be assigned to a user. An anonymous ID allows for separate health reports from the same individual to be linked together without associating identifying information with the data.

Another way to encourage participation is through minimizing the effort needed for a user to interact with the system. For instance, a free-text entry system with intelligent spelling correction can be provided for data entry. Text mining algorithms can be employed to extract structured data from the entered free-text. In another embodiment, a bar-code reader can be used to scan the label of a medication bottle. By way of another example, at the time of each report, the user can be asked health-related questions. The questions can be selected at random from a large library of questions or more particularly tailored to the user's condition/context. Data can be entered at will (e.g., symptoms such as chest pains, level of arthritis pain, etc.) and/or the user can request that reminders be sent (e.g. periodic email, etc.). The individual data can be aggregated (e.g., collected en masse or selected based on the type of data to be analyzed or otherwise refined) in whole or in part across a large group and patterns/correlations can be discovered from the data using, for example, statistical methods. Any suitable statistical method can be used, such as Fisher's Exact Test (if both variables are binary), Mann-Whitney (if one variable is binary and the other is a number), and Spearman correlation (if both variables are numbers).

By way of yet another example, users can be presented with questions based on the results of previously analyzed data. For instance, statistical methods can be used to analyze data input by users who happen to report or who are prompted to report side effects while taking medications. In this example, if a correlation between Drug A and a side effect and a correlation between Drug B and the same side effect are detected and rise above a threshold, subsequent users can be presented with questions about Drug A, Drug B and the side effect. In particular, if any person input information about Drug A, Drug B or the side effect spontaneously, he or she could be asked about the other two. Alternatively or additionally, other users could be chosen at random to be asked about all three. Data input by users who answered questions pertaining to all three (e.g., a stratified sample) can be subjected to standard multivariate tests (e.g., a logistic regression of Drug A and Drug B on the side effect) to determine, for instance, if the two drugs interact to produce the side effect. Based on the results of the analysis, appropriate response(s) can be implemented (e.g., if a user reports he/she is taking Drug A, the user can be asked about Drug B and be advised about the likely side effect if taking both).

The interface can be programmed to maximize the value of information while minimizing the effort required to provide the information. For example, questions can be selected automatically in a manner so as to converge on meaningful information and to otherwise maximize the value of the extracted information in conjunction with the already mined data. One way to accomplish this is to increase the number of patients being asked the same questions when the answers to randomized questions start showing a distinct but weak pattern in order to confirm the pattern. The patterns in free text may suggest an effect that needs further exploration with new questions, for instance, questions that were previously found to be informative when asked in conjunction with the observed pattern.

Another way to increase usage is to increase awareness of the service. By way of example, health-related keywords can be purchased on a search site (e.g. MSN SEARCH). When a user types a query containing one of the purchased keywords, the user is presented with a link to a web site enabling data collection. Other advertising venues can be employed (e.g. print, radio, TV, etc) and these ads can contain catchy phrases to describe the process of filing a report (e.g., encourage people to send in their “drug bugs”).

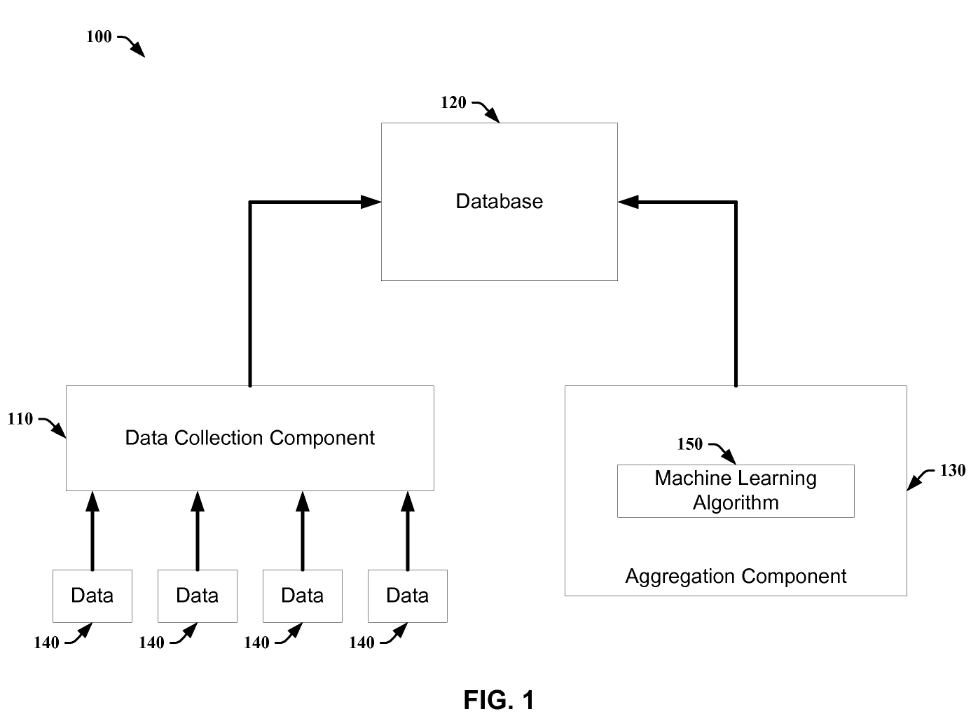

FIG. 1 schematically illustrates one example of a system 100 that facilitates large-scale reporting of health-related data. The term large-scale is used herein to mean large enough to produce the desired results (e.g., large enough to facilitate discerning one or more patterns from health information related to a non-selected population). The system 100 comprises a data collection component 110, a database 120 and an aggregation component 130. The data collection component 110 collects data 140 on a large-scale from a non-selected population and provides the data 140 to the database 120. The term non-selected is used herein to differentiate from studies on selected populations such as conventional clinical trials (which enroll subjects according to enrollment criteria) and public health studies (which focus on particular groups within the population). The aggregation component 130 applies a machine-learning algorithm 150 to the database 120 to discern patterns in the data 140. The data collection component 110 and aggregation component 130 can be the same process executing on a single or a plurality of computers or multiple processes executing on a single or a plurality of computers. Similarly, the database 120 can be a single datastore or multiple datastores. Moreover, the components 310, 330 and the database 320 can be implemented by software or combinations of software and hardware.

The data collection component 110 can collect any type of data 140 including but not limited to biological, pathophysiological, physiological, medical, healthcare and/or otherwise health-related. The data 140 can be, for example, a drug-related event, a symptom, and/or genetic information. The data collection component 110 can collect data 140 in any form including but not limited to textual, graphical, photographic, sound, speech, video, multimedia and the like. By way of example, the data collection component 110 can allow for free-text analysis. In this embodiment, rather than prompting a user with forms, a user enters the data in free-text form and the system automatically extracts and structures data from the free-text. The free-text analysis can include intelligent spelling correction or voice recognition. The user can be a consumer or a provider of healthcare services or any other source of health-related information. The data component 110 also can allow for input to be received in multiple forms in combination, such as both free-text and survey forms. The data 140 even can be introduced in the form of an activity, such as a memory game that a user plays to assess memory function.

The data collection component 110 can automatically obtain data 140, such as by querying a provider database (not shown). The data 140 can be provided to the data collection component 110 from any input means, such as a PDA, telephone, bar code reader, computer, keyboard, mouse, microphone, touchscreen, database, cell phone, etc. To promote participation through convenience of use, sites for data entry, such as kiosks with computer terminals, can be provided at public and other locations.

In one embodiment, the data collection component 110 can collect the data 140 anonymously such that no identifying information is linked to the data 140. By way of example, a user can be anonymously issued an ID, and use this ID to log on to the system 100 to enter data 140. The data from a particular individual can be linked together via this ID without associating the user's identity with the data. Alternatively, the data can be received by the data collection component 110 in conjunction with identifying information, and the data collection component 110 can filter the identifying information (privacy filter) prior to storage in the database 120. In addition, the data collection component 110 can employ various security measures to obtain data 140, such as a Human Interactive Proof (HIP) to verify that a human being (rather than an automated process) is providing the data 140.

The data 140 in whole or in part is sent to the database 120 to be stored for use by the aggregation component 130. The aggregation component 130 aggregates individual data across a large group and facilitates automatically detecting one or more patterns from the data 140 at least in part by utilizing machine-learning techniques 150 to mine the database 120. The term pattern as used herein includes but is not limited to trends, associations, correlations, connections, links, relationships, etc. By way of example, the aggregation component 130 can detect a correlation between the use of a certain medication and, for instance, a symptom across a large group of people. The aggregation component 130 can be structured to accord different weights to different data. For instance, data from a physician can be given a higher weight than data from a patient. By way of another example, data more likely to be accurate can be assigned a greater weight. Moreover, the aggregation component 130 can classify the data 140 according to demographics (e.g., age, gender, race, etc.) in order to facilitate recognizing demographic-specific patterns.

The patterns (e.g., correlations) can be ascertained via any suitable method, for example, by employing an algorithm 150 such as the statistical methods explained above (Fisher's Exact Test, Mann-Whitney, Spearman correlation). Additionally or alternatively, the system 100 can employ an algorithm 150 that uses low-order sufficient statistics and statistical methods that can make inferences with missing data (e.g., expectation-maximization (EM) algorithm). Any machine-learning algorithm 150 can be employed, such as neural networks, expert systems, Bayesian belief networks, fuzzy logic, data fusion engines and the like. The aggregation component 130 also can employ combinations of various artificial intelligence techniques to discern patterns.

Optionally, a human intervention step can be combined with the machine-learning algorithm 150 to discern patterns from the data 140. By way of example, a human editor can inspect and even test (e.g., through formal or informal clinical trials) some or all of the patterns ascertained by the automated portion 150 of the system 100 before the system 100 accepts a pattern as true or likely to be true.

In one embodiment, the data collection component 110 and the aggregation component 130 can function together to collect and aggregate the data, such as by tailoring questions to converge on the most valued information. By way of example, the data collection component 110 can present a user with a question and the aggregation component 130 can apply machine-learning techniques 150 to the answer to determine a suitable follow-up question. A suitable follow-up question can be based on the user's response and/or patterns detected from the responses given by other users to the same or a similar question, for instance, to confirm a pattern. By way of example, a user can be presented with the question “How are you feeling today?” If the user's response is “I do not feel well today,” the aggregation component 130 can choose the follow-up question “Please tell me about your symptoms.” If the user responds “I have chest pain” and the system 100 has acquired data 140 from other users taking a particular type of medication that shows a pattern of chest pain associated with that particular medication, the system 100 can respond by asking the user “Please tell me what medications you are taking.” By way of another example, a physician can be queried about the number of patients he/she has treated who are on a particular medication and who have experienced symptoms, such as chest pain. Moreover, questions can be tailored to the personal characteristics of the user, such as education level, language, culture and dialect.

In another embodiment, the system 100 can facilitate the design of personalized diagnostic and therapeutic regimens as well as alert/remind a user about behavior modifications that would benefit the user's health. By way of example, the data collection component 110 can obtain patient-specific genetic information as well as a variety of other relevant information from a user and/or provider and/or device, etc. The machine-learning component 150 can correlate the patient-specific genetic information with the other relevant information to draw conclusions about a user's health needs. For instance, if the patient-specific genetic information indicates that the person has a genetic susceptibility to heart disease and other relevant information indicates that the person smokes cigarettes and/or eats a high-fat diet and/or has a high cholesterol, the user can be sent an alert notifying him/her of various beneficial behavioral modifications that could reduce his/her risk of a heart attack (e.g., quitting smoking, reducing dietary fat, etc.) as well as advantageous medical therapies (e.g., cholesterol lowering drugs). By way of another example, if the patient-specific genetic information indicates the person is at high risk for a certain type of cancer, the person can be sent a reminder/alert to discuss with their physician various preventative therapies as well as useful diagnostic tests.

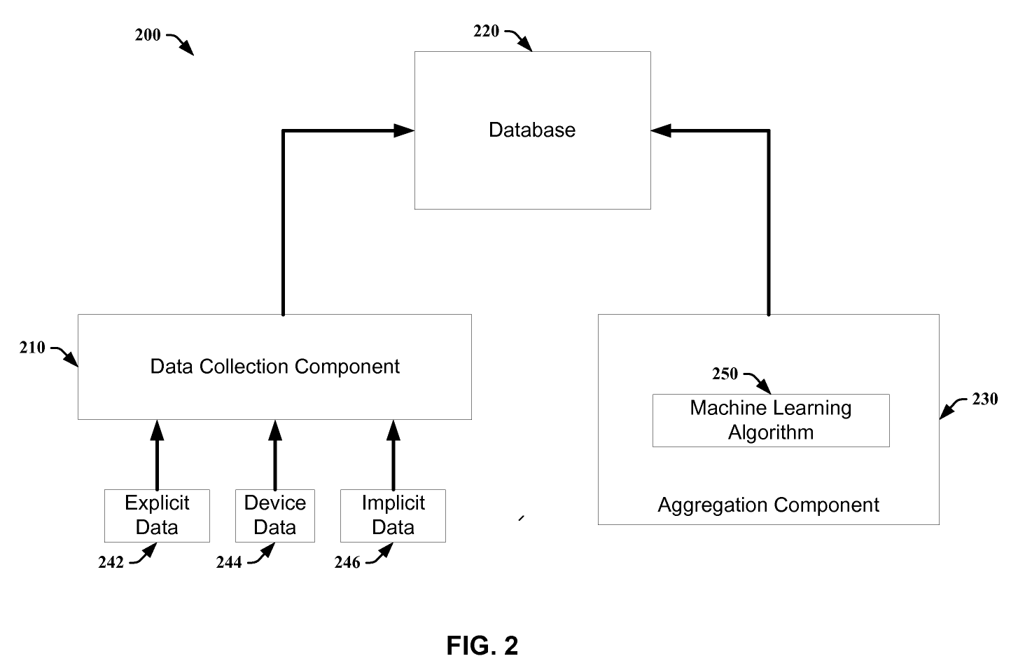

FIG. 2 schematically illustrates another example of a system 200 that facilitates large-scale reporting of health-related data. The system 200 comprises a data collection component 210, a database 220 and an aggregation component 230. The data collection component 210 can collect data 242-246 from a variety of different sources on a large-scale relating to a non-selected population and provides the data 240-260 in whole or in part to the database 220. The aggregation component 230 applies a machine-learning algorithm 250 to the database 220 to facilitate drawing conclusions from the data 242-246. The data collection component 210 and aggregation component 230 can be the same process executing on a single or a plurality of computers or multiple processes executing on a single or a plurality of computers. Similarly, the database 120 can be a single datastore or multiple datastores. Moreover, the components 210, 230 and the database 220 can be implemented by software or combinations of software and hardware.

As explained in relation to FIG. 1, a variety of different input means can be employed to provide the data 242-246. Data 242-246 can be received in a variety of different forms, such as explicit data 242 and/or implicit data 246. By way of example, explicit data 242 can be data directly entered by a patient or a provider (e.g., physician, nurse, pharmacy, hospital, institution, agency, device data 244, etc.).

In order to encourage participation, the data collection component 210 can automate the data collection process in whole or in part. For instance, the data collection component 210 can acquire implicit data 246. Implicit data 246 as used herein means data that is a by-product of the activities that people engage in and/or information that is provided to the system 200. By way of example, implicit data 246 can be acquired from explicit data 242. For instance, a user can be asked a broad question by the system 200, such as “How are you feeling?” The user can enter his/her answer in free-text form and the system 200 can interpret this answer to extract implicit data 246. If the user's answer is “I am not feeling well and my eyes are red and itchy and I am sneezing quite a bit,” the system 200 can determine that the user has allergies. By way of another example, the data collection component 210 can automatically acquire a user's prescription medication history by querying a pharmacy database (not shown). By analyzing the user's refill history, the system 200 can determine whether the user is taking the medication as prescribed. The system 200 can employ various techniques and methodologies to gather the implicit data 246, such as a machine-learning algorithm 250.

The data collection component 210 also can receive device data 244. The data collection component 210 can interrogate devices to obtain the device data 244 and/or the devices can initiate data transfers. Any form of communication between the system 200 and the devices can be employed, such as direct connection, wireless connection, network connection, etc. By way of example, device data 244 can be data received from a smart scale that can automatically connect with the system 200 to send a patient's weight. Other devices that can send device data 244 include pacemakers, defibrillators, thermometers, consumer healthcare devices, electronic calendars, PDAs, cell phones, exercise equipment, and the like. For instance, a user can keep track of how often they have a particular symptom by entering this information into his/her electronic calendar. This information can be uploaded to the data collection component 210 by the electronic calendar, for instance, upon receiving a reminder, by user indication, and/or automatically without receiving a prompt. Alternatively, the system 200 can interrogate the electronic calendar. By way of another example, the devices can connect with the system 200 by using a platform such as MICROSOFT.NET.

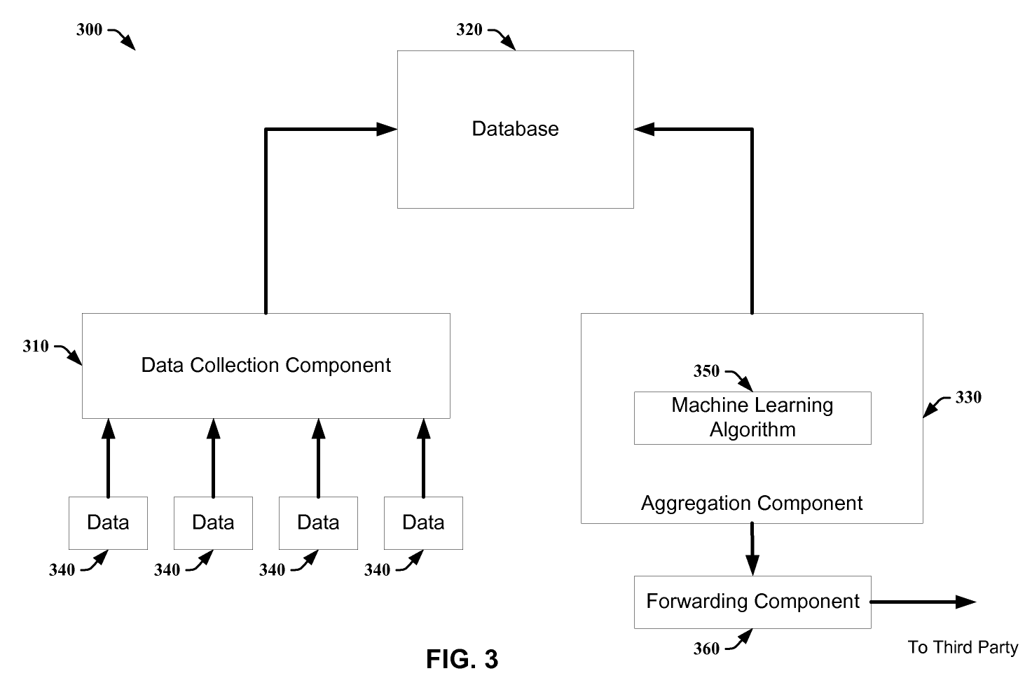

FIG. 3 schematically illustrates another example of a system 300 that facilitates large-scale reporting of health-related data. The system 300 comprises a data collection component 310, a database 320, an aggregation component 330 and a forwarding component 360. The data collection component 310 collects data 340 on a large-scale relating to a non-selected population and provides the data 340 in whole or in part to the database 320. The aggregation component 330 applies a machine-learning algorithm 350 to the database 320 to discern patterns in the data 340. The forwarding component 360 forwards at least one pattern to a third party. The forwarding component 360 can forward information in any form, including but not limited to a data signal, online transmission, wirelessly, email, telephone, facsimile, blackberry, cell phone, etc.

The components 310, 330 and 360 can be the same process executing on a single or a plurality of computers or multiple processes executing on a single or a plurality of computers. Similarly, the database 320 can be a single datastore or multiple datastores. Moreover, the components 310, 330 and 360 and the database 320 can be implemented by software or combinations of software and hardware.

The third party that receives the patterns from the system 300 can be a patient, a provider (e.g., physicians, hospitals, pharmacies, nursing homes, etc.), a governmental entity (e.g., Food & Drug Administration (FDA), lawmakers, etc.), a private entity (e.g., pharmaceutical companies, medical device companies, distributors, drug safety watchdog groups, insurance companies, AARP, etc.) and any other interested parties. By way of example, by mining the database 320 for associations between adverse events and medications, the system 300 can facilitate the early detection of drug side effects and/or drug interactions. The system 300 can forward this information to alert interested parties, such as the company that manufactures the medication(s) associated with the adverse event and/or the FDA. By way of another example, a user can register with the system 300 and sign-up for alerts relating to a medication the user is taking. If a pattern associated with the user's medication is recognized by the system 300, the forwarding component 360 can send an alert to the user notifying the user of the relationship.

The system 300 also can facilitate the detection of counterfeit drugs. By way of example, the data collection component 310 can collect information relating to a user's medication and physiological status and correlate this information to determine if the medication is producing the intended effect. In one embodiment, the user can be queried about medications and the specific effects of those medications. Alternatively, a device can provide an output corresponding to a measure of the patient's response to the therapy. For instance, if a patient is taking blood pressure medication, the patient can enter the medication's name as well as the patient's blood pressure measurements via the data collection component 310. The system 300 can store this information over time and determine if the patient is adequately responding to the therapy, for instance, by employing machine-learning techniques 350. If the system 300 determines that the patient's response to the medication is inadequate, the forwarding component 360 can send the patient an alert.

The system 300 can forward the patterns to the interested parties in return for a fee. The fee can be structured in any manner, for instance, a fee can be charged for each alert sent to the third party. Alternatively, a subscription service can be provided such that a third party is charged a fee for unlimited or limited access to information inferred by the system 300 for a period of time.

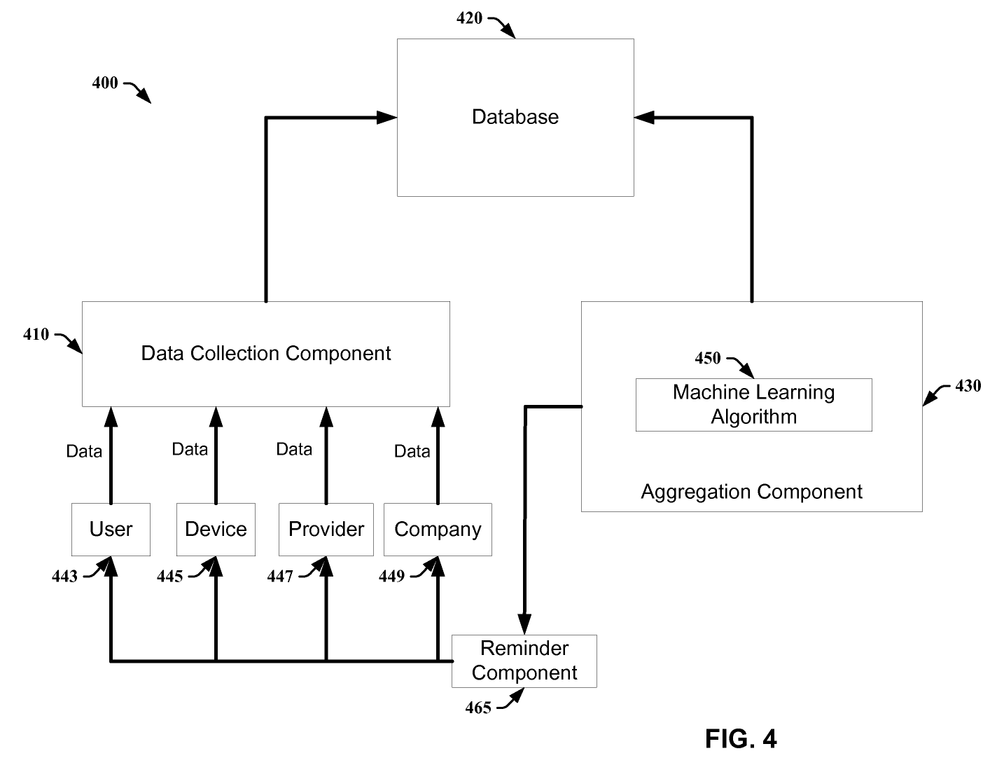

FIG. 4 schematically illustrates another example of a system 400 that facilitates large-scale reporting of health-related data. The system 400 comprises a data collection component 410, a database 420, an aggregation component 430 and a reminder component 365. The data collection component 410 collects data 440 on a large-scale from a non-selected population and provides the data 440 in whole or in part to the database 420. The aggregation component 430 applies a machine-learning algorithm 450 to the database 420 to discern patterns in the data 440. The reminder component 465 sends reminders to various entities 443-449. The reminder component 465 can send reminders in any form, including but not limited to a data signal, online transmission, wirelessly, email, telephone, facsimile, blackberry, cell phone, etc.

The components 410, 430 and 465 can be the same process executing on a single or a plurality of computers or multiple processes executing on a single or a plurality of computers. Similarly, the database 420 can be a single datastore or multiple datastores. Moreover, the components 410, 430 and 465 and the database 420 can be implemented by software or combinations of software and hardware.

The reminder component 465 can send reminders to remind various entities 443-449 to enter data. The reminders can be sent to any party/entity that requests to be reminded, such as users 443 (e.g., individuals, etc.), devices 445 (e.g., electronic calendars, consumer healthcare devices, pacemakers, etc.), providers 447 (e.g., physicians, nurses, hospitals, insurance companies, pharmacies, etc.) and companies 449 (e.g. pharmaceutical manufacturers, medical device manufacturers, distributors, etc.). Alternatively, the reminder component 465 can send out reminders automatically without receiving a request. For instance, the machine-learning component 450 can determine that information is missing from a profile and signal the reminder component 465 to send a request to the information source. Optionally, a fee can be charged for the reminder service. The reminder component 465 also can send alerts of the type described in relation to FIG. 3.

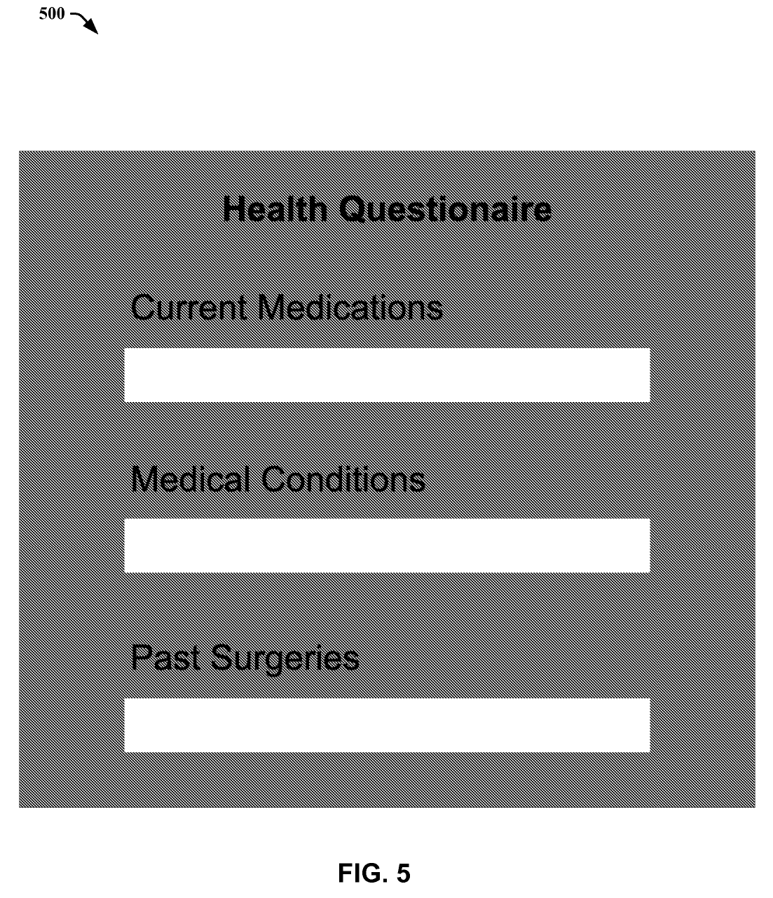

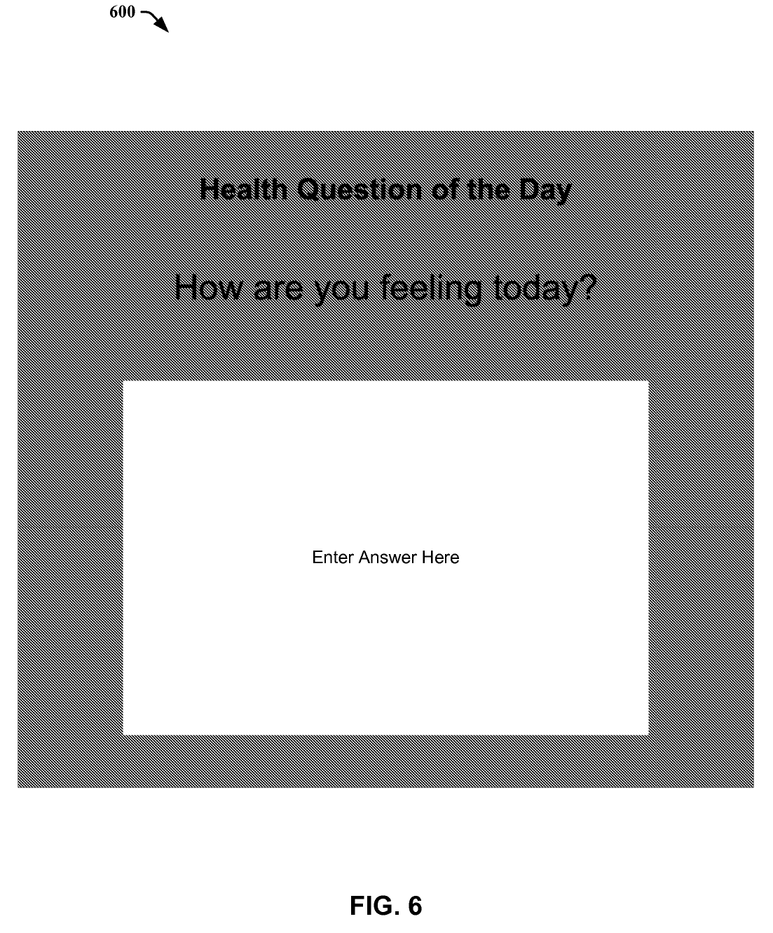

FIGS. 5 and 6 are illustrations of two examples of an interface for reporting health-related information. FIG. 5 illustrates a survey form 500 provided to a user by a data collection component to obtain information about the user. FIG. 6 illustrates a free-text form 600 provided to a user by a data collection component to obtain information about the user. A user can enter the information in any format and the data collection component will extract structured information by employing, for instance, an artificial intelligence process.

The systems described above can be implemented on a network, in whole or in part, by data signals. These manufactured data signals can be of any type and can be conveyed on any type of network. For instance, the systems can be implemented by electronic signals propagating on electronic networks, such as the Internet. Wireless communications techniques and infrastructures also can be utilized to implement the systems.

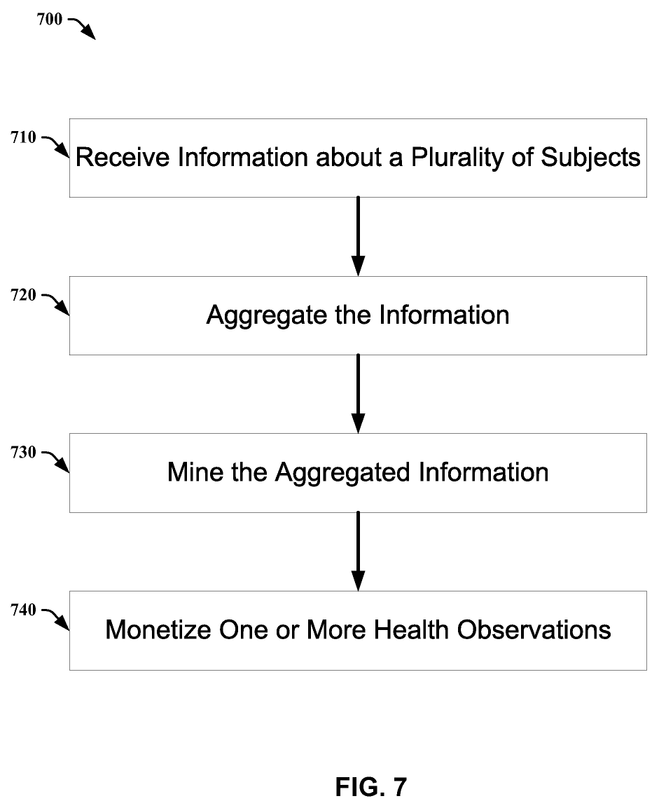

FIG. 7 is a flowchart representing one example of a method 700 of extracting health observations from information obtained on a macro-scale. The method 700 can be implemented by computer-executable instructions stored on computer-readable media or conveyed by a data signal of any type. The method 700 can be implemented at least in part manually. The term macro-scale as used herein means on a scale sufficient to allow a machine-learning component to make reasonably valid inferences from aggregated data.

At step 710, information about a plurality of self-selected subjects is received. The information can be obtained from a consumer or a provider of healthcare services or any other source of information, such as a device or an electronic calendar. At step 720, the information is aggregated. At step 730, the aggregated data is mined. The aggregated information can be mined at least in part by employing a data-mining algorithm to infer one or more health observations from the aggregated information. The term health observation as used herein includes but is not limited to trends, associations, correlations, connections, links, relationships, etc. At step 740, the one or more health observations are monetized. Monetizing the health observations can be accomplished, for instance, by charging an interested party a fee for access to the health observations. The fee can be structured in any manner, for instance, a fee can be charged for each alert sent to a third party. Alternatively, a subscription service can be provided such that a third party is charged a fee for unlimited or limited access to health observations over a period of time. The method 700 can be repeated an unlimited number of times as needed to generate health observations.

Any type of information can be aggregated including but not limited to biological, pathophysiological, physiological, medical, healthcare and/or otherwise health-related. The information can be, for example, a drug-related event, a symptom, and/or genetic information. The data can be collected in any form including but not limited to textual, graphical, photographic, sound, speech, video, multimedia and the like. By way of example, the data can be collected by employing a free-text analysis, which optionally can include intelligent spelling correction or voice recognition. The data can be explicitly, implicitly and/or automatically input. The information can be entered by any input means, such as a PDA, telephone, bar code reader, computer, keyboard, mouse, microphone, touchscreen, database, cell phone, etc. Sources of information can be sent reminders either by request and/or inferred reminders.

In one embodiment, the information can be collected anonymously such that no identifying information is linked to the information. Alternatively, the data can be received in conjunction with identifying information and stripped of the identifying information by a privacy filter. Security measures can be employed in the information collection process, such as a Human Interactive Proof (HIP) to verify that a human being (rather than an automated process) is providing the data.

The health observations (e.g., correlations) can be ascertained via any suitable method, for example, by employing the statistical methods explained above (Fisher's Exact Test, Mann-Whitney, Spearman correlation). Additionally or alternatively, the health observations can be ascertained via an algorithm that uses low-order sufficient statistics and statistical methods that can make inferences with missing data (e.g., expectation-maximization (EM) algorithm). Other example of data-mining methods include but are not limited to neural networks, expert systems, Bayesian belief networks, fuzzy logic, data fusion engines and the like as well as combinations of various artificial intelligence techniques capable of discerning patterns. Optionally, a human intervention step can be added to the process in order to mine the data. By way of example, a human editor can inspect and even test (e.g., through formal or informal clinical trials) some or all of the inferences provided by the data-mining algorithm.

In mining the aggregated data, information can be accorded different weights, for instance, information from a pharmacy can be given a higher weight than information from a patient. By way of another example, information more likely to be accurate can be assigned a greater weigh. By way of yet another example, the machine-learning algorithm can classify the information according to demographics (e.g., age, gender, race, etc.) in order to facilitate making demographic-specific health observations.

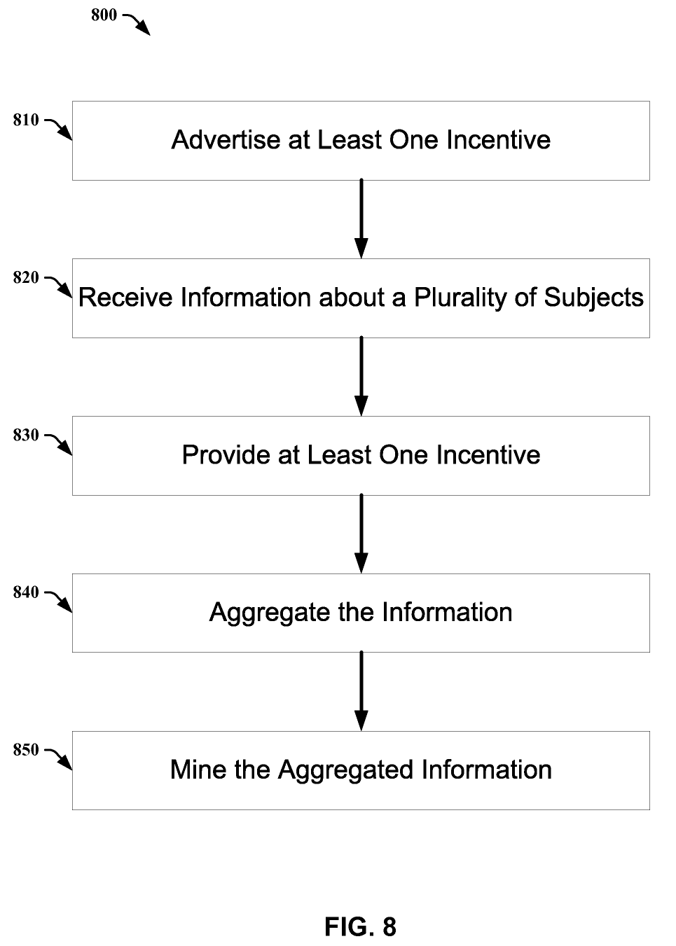

FIG. 8 is a flowchart representing another example of a method 800 of extracting health observations from information obtained on a macro-scale. The method 800 can be implemented by computer-executable instructions stored on computer-readable media or conveyed by a data signal of any type. The method 800 can be implemented at least in part manually.

At step 810, at least one incentive to supply information is advertised. The incentive can be advertised, for example, on a search site upon entering a search string containing one or more keywords. Any other means of advertising can be used to advertise the incentive, such as print, TV, radio, online ad, etc. At step 820, information about a plurality of self-selected subjects is received. At step 830, the incentive is provided to the self-selected subject. The incentive can be of any type and can be a requirement or a bonus. For instance, an insurance company (e.g., Medicare, Medicaid, private insurer, etc.) can require a subscriber to file a report as a condition of renewing a prescription for medication or to qualify for a lower co-payment/rate. By way of another example, coupons for discounts on goods and services can be offered. At step 840, the information is aggregated. At step 850, the aggregated data is mined. The aggregated information can be mined at least in part by employing a data-mining algorithm to infer one or more health observations from the aggregated information. The method 800 can be repeated an unlimited number of times as needed to generate health observations. Moreover, the method 800 is not limited to the order shown in the flowchart. For instance, step 830 can be performed prior to step 820.

As described in relation to FIG. 7 above, the information can be entered anonymously or stripped of identifying information. The information can be obtained from a consumer or a provider of healthcare services or any other source of information, such as a device or an electronic calendar, can be in any form and can be provided by any input means. The data-mining algorithm also can be of any type.

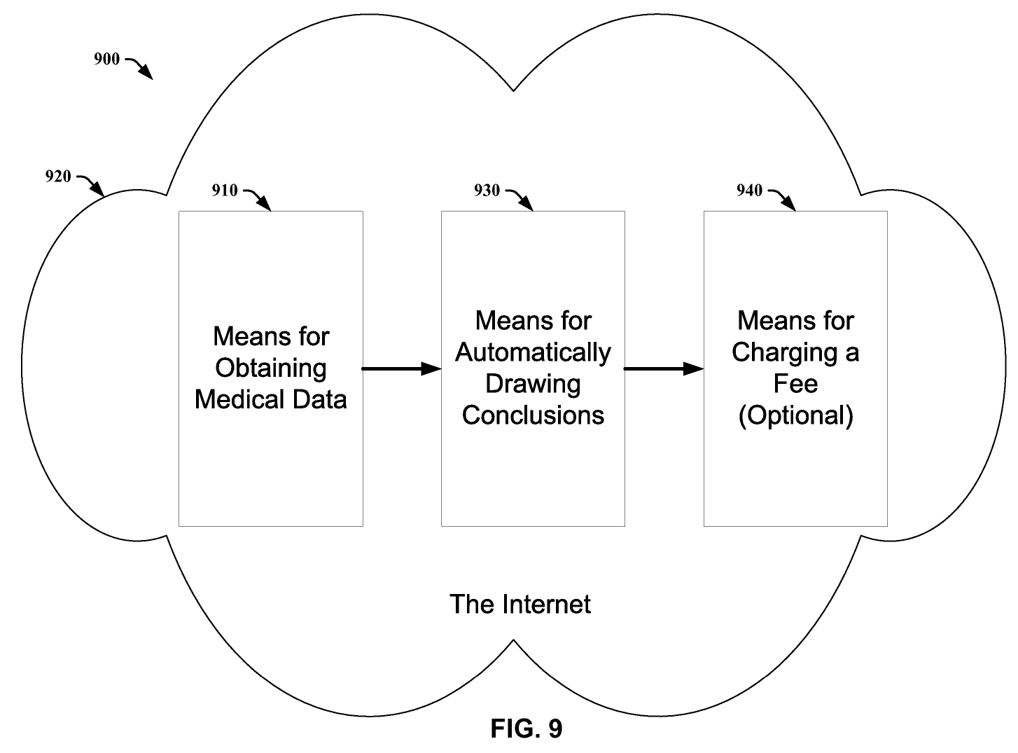

FIG. 9 is a block diagram of one example of an online system 900 to facilitate global medical data analysis. The term global as applied to the online system 900 and used herein means an online system capable of reaching a geographically, wide-spread population. The system 900 includes means for obtaining medical data from a global, unselected population 910 via the Internet 920 and means for automatically drawing conclusions from the medical data 930. The means for automatically drawing conclusions from the medical data 930 can employ one or more artificial intelligence algorithms to draw at least one conclusion from the medical data. Optionally, the system 900 can include a means for charging a fee 940. In one embodiment, the fee can be charged to receive the conclusions drawn by the artificial intelligence algorithms. In another embodiment, the fee can be assessed to gain access to the system 900.

The structures and algorithms described in relations to FIGS. 1-8 above can be used to implement the means 910, 930 and 940 of the system 900. As described in relation to FIGS. 1-8, the data can be entered anonymously or stripped of identifying information. The information can be obtained from a consumer or a provider of healthcare services or any other source of information, such as a device or an electronic calendar, can be in any form and can be provided by any input means. The data-mining algorithm also can be of any type.

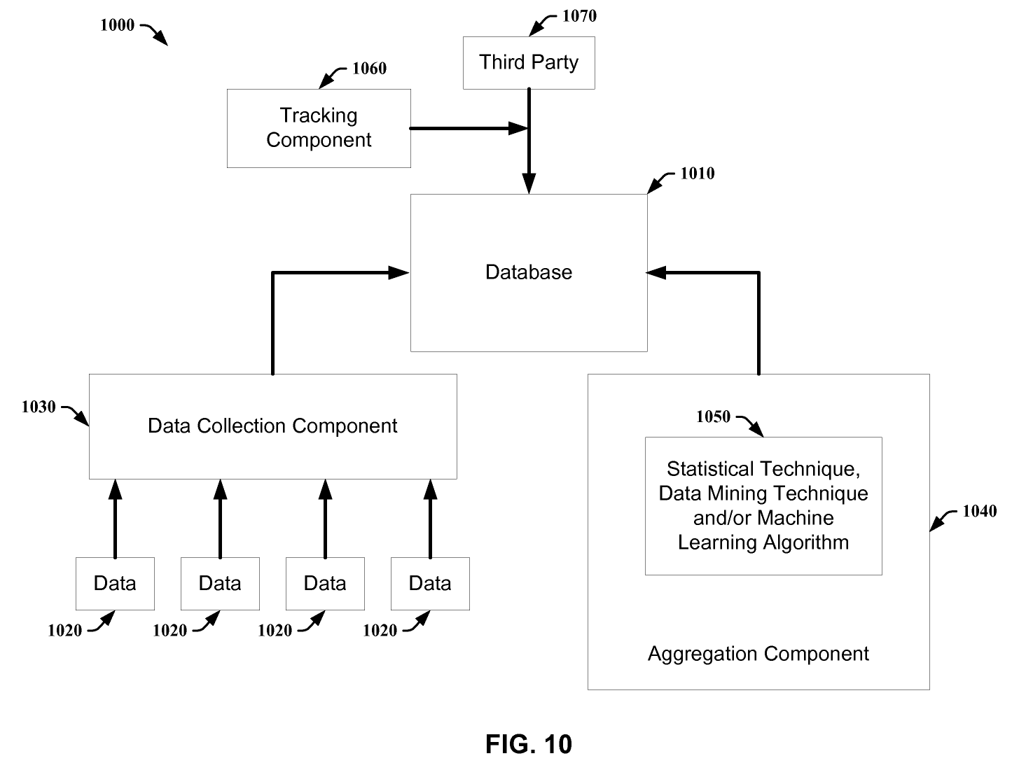

A database of data gathered as described in relation to FIGS. 1-9 can be further used to generate revenue as will be described in relation to FIGS. 10-16. FIG. 10 is a block diagram of one example of a system 1000 that facilitates monitoring a database 1010 of unclean health-related data 1020 pertaining to a non-selected population and collected on a large-scale. Examples of the type of data include but are not limited to those described in relation to FIG. 1. The system 1000 can be implemented on a single server or in a distributed environment, for instance, on two or more servers. The system 1000 includes a data collection component 1030 to collect the unclean health-related data 1020 and to store at least some of it in the database 1010. The unclean health-related data 1020 can be provided by entities interfacing with the system 1000 via an Application Programming Interface (e.g., MICROSOFT.NET).

An aggregation component 1040 facilitates automatically ascertaining at least one pattern from the unclean health-related data 1020 at least in part by applying one or more of a statistical technique, a data mining technique and a machine-learning technique 1050 to the database. More detailed examples of this are described in relation to FIGS. 1-9. A tracking component 1060 monitors a third party's 1070 use of the database. The tracking component 1060 can further determine a fee to be charged for the third party 1070 use of the database 1010.

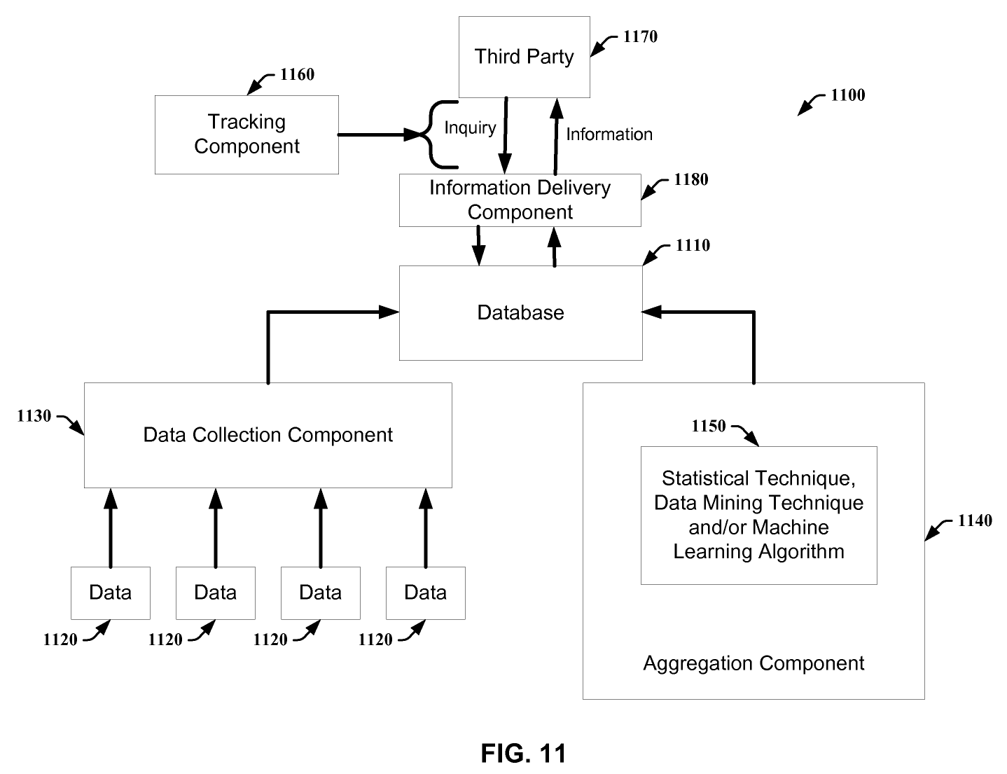

FIG. 11 is a block diagram of another example of a system 1100 that facilitates monitoring a database 1110 of unclean health-related data 1120. In this embodiment, the third party 1170 use of the database is an inquiry from a member of the non-selected population. The inquiry can relate, for instance, to the member's health and/or wellness. The inquiry can be explicit or implicit (e.g., based on the user's context, etc.). The inquiry can include automatically collected information pertaining to the member's health and/or wellness, for instance, by automatically querying a device (e.g., smart scale, cardiac pacemaker, glucose meter, pedometer, etc.).

The system 1100 includes an information delivery component 1180 to provide the member with information relating to the inquiry. The information delivery component 1180 can interface with the database 1110 to retrieve data pertaining to the member, such as a drug-related event, a symptom, a device output, an activity, and/or patient-specific genetic information or any other type of information that would facilitate providing health and/or wellness services. The information delivery component 1180 then can formulate information to provide to the member in response to the inquiry and/or prompt the member with follow up questions to further narrow the subject matter at issue.

The information provided to the member can be, for instance, a diagnosis and/or a health provider appointment and the system 1100 can charge the member a fee for providing this information. Additionally or alternatively, if the information sent to the member is a health provider appointment, the system 1100 can charge the health provider a referral fee. Other examples of information that can be provided to the member include a treatment option (e.g., over-the-counter medication recommendation, recommendation to seek emergency treatment, etc.) or other health/wellness advice such as information on diet, exercise or other activities, and/or appropriate nutritional supplements. The information delivery component 1180 can employ any suitable technique to determine the information to provide to the member. Examples of suitable techniques include using artificial intelligence techniques to arrive at a conclusion for instance, neural networks, expert systems, Bayesian belief networks, fuzzy logic, data fusion engines and the like as well as combinations thereof. Moreover, a human intervention step can be combined with the artificial intelligence techniques to arrive at a conclusion.

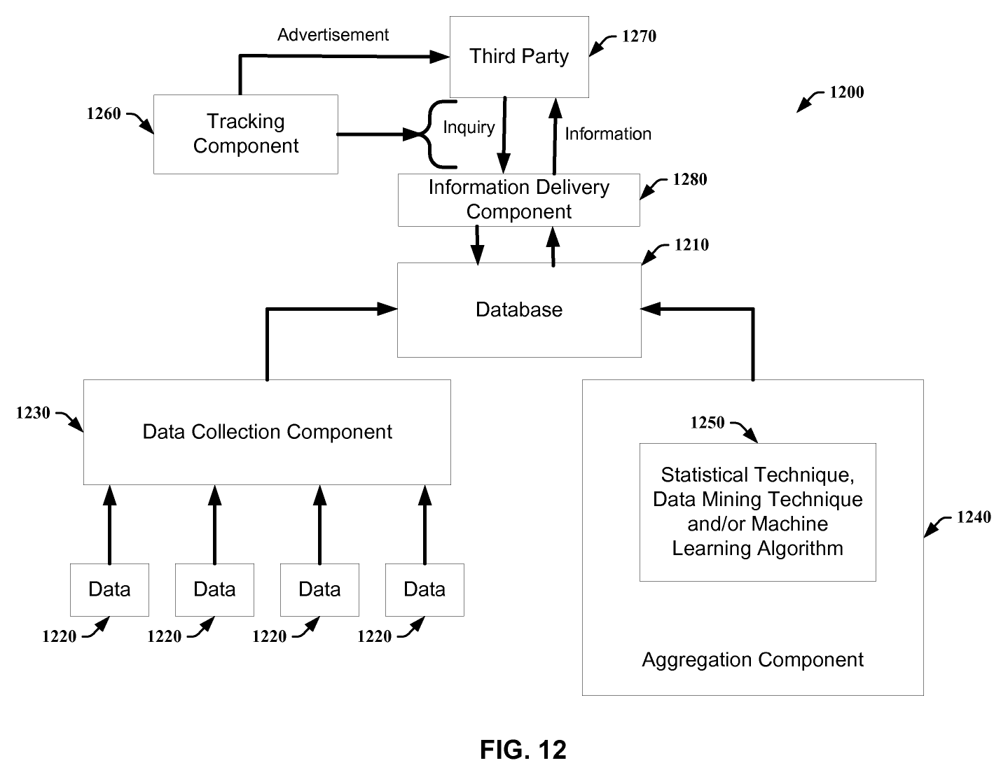

FIG. 12 is a block diagram of yet another example of a system 1200 that facilitates monitoring a database 1210 of unclean health-related data 1220 from a non-selected population. In this embodiment, the third party 1270 is a member of the non-selected population and the tracking component 1260 further provides an advertisement to the member. The tracking component 1260 can further determine a fee to be charged to an entity placing the advertisement (not shown). The particular advertisement chosen by the tracking component 1260 to display to the member can be based, for instance, on an inquiry placed by the member. The tracking component 1260 can employ any suitable technique to determine the fee to charge the entity placing the ad, for instance, by holding an auction in which advertisers bid on keywords/phrases. Then, if these keywords/phrases are entered by the member as part of an inquiry or inferred based on the inquiry, the highest bidder's ad can be presented to the member.

As used in this application, the term “component” is intended to refer to a computer-related entity, either hardware, a combination of hardware and software, software, or software in execution. For example, a component can be, but is not limited to, a process running on a processor, a processor, an object, an executable, a thread of execution, a program, and a computer. By way of illustration, an application running on a server and/or the server can be a component. In addition, a component can include one or more subcomponents. One or more components can reside within a process and/or thread of execution and a component can be localized on one computer and/or distributed between two or more computers.

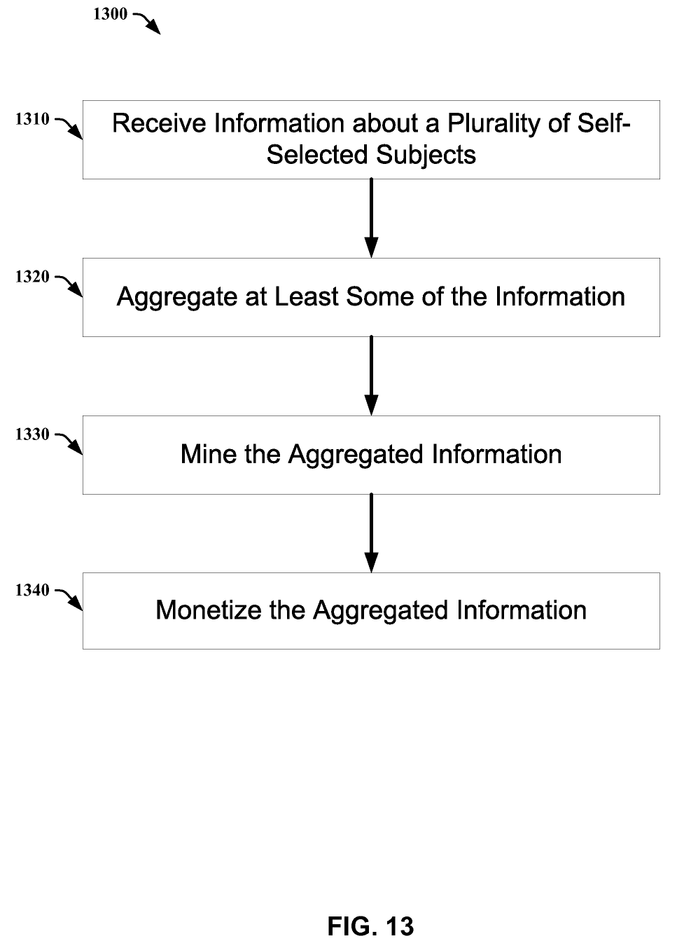

FIG. 13 is a flowchart of one example of a method 1300 of monetizing information obtained on a macro-scale. At step 1310, information about a plurality of self-selected subjects is received and at step 1320, at least some of the information is aggregated. The aggregated information is mined 1330 at least in part by employing one or more of a statistical algorithm, a data-mining algorithm and a machine-learning algorithm to infer one or more health observations from the aggregated information. At step 1340, the aggregated information is monetized. Monetizing the aggregated information includes but is not limited to determining advertising fees and/or determining information retrieval fees as explained in greater detail above.

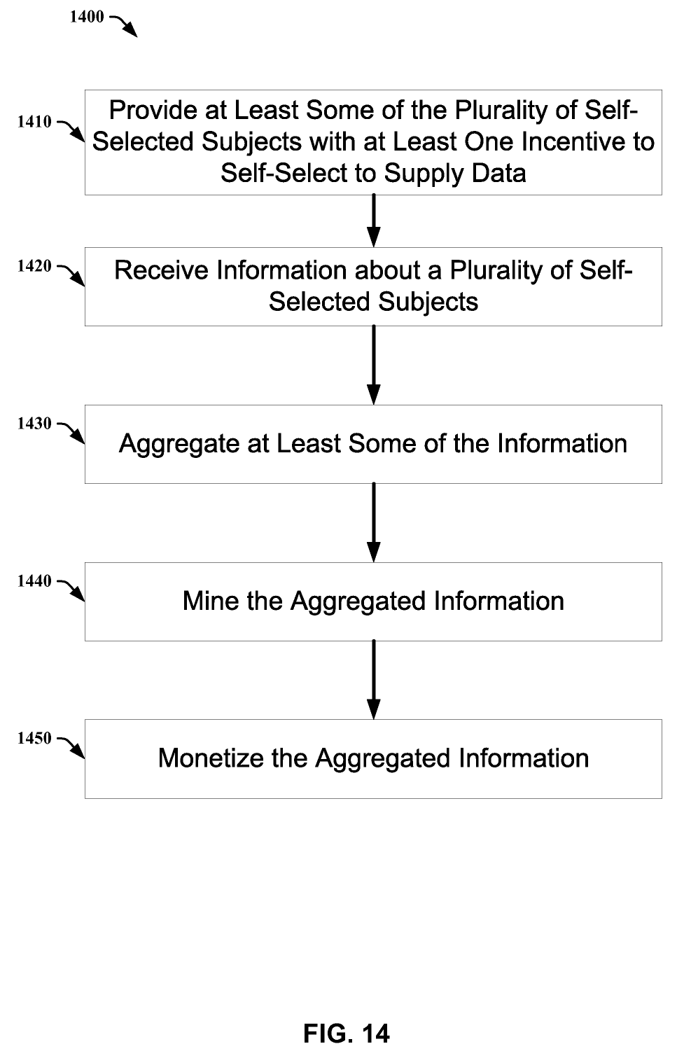

FIG. 14 is a flowchart of another example of a method 1400 of monetizing information obtained on a macro-scale. The method includes all of the steps of FIG. 13 and further includes the step of providing at least some of the plurality of self-selected subjects with at least one incentive to self-select to supply information 1410. Incentives include but are not limited to those described in relation to FIG. 8.

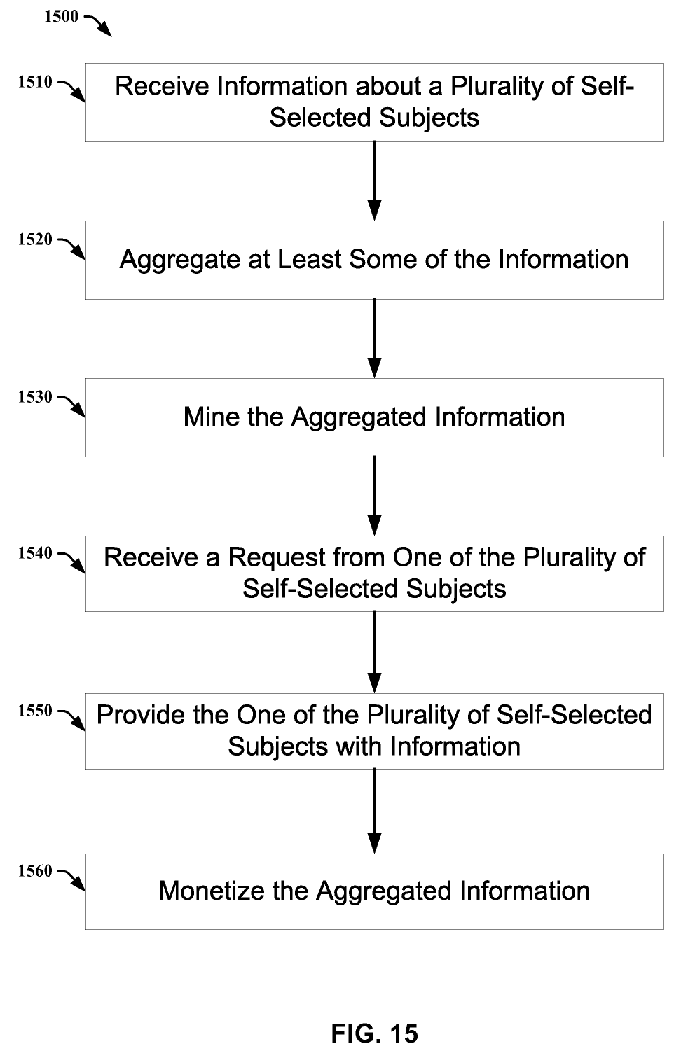

FIG. 15 is a flowchart of another example of a method 1500 of monetizing information obtained on a macro-scale. The method includes all of the steps of FIG. 13 and further includes the steps of receiving a request from one of the self-selected subjects 1540 and providing the self-selected subject with information pertaining to the request 1550. The step of monetizing the aggregated information 1560 includes but is not limited to delivering an advertisement to the self-selected subject, sending an invoice to one or more health-care entities in return for providing the self-selected subject with information about the one or more health-care entities and/or charging the self-selected subject for receiving the information pertaining to the request. Advertising fees can be determined by, for instance, keyword/keyphrase auctions. When a self-selected subject's request includes a keyword/keyphrase (or one or more are inferred from the request), the auction winner's ad can be presented to the self-selected subject and the auction winner can be billed accordingly.

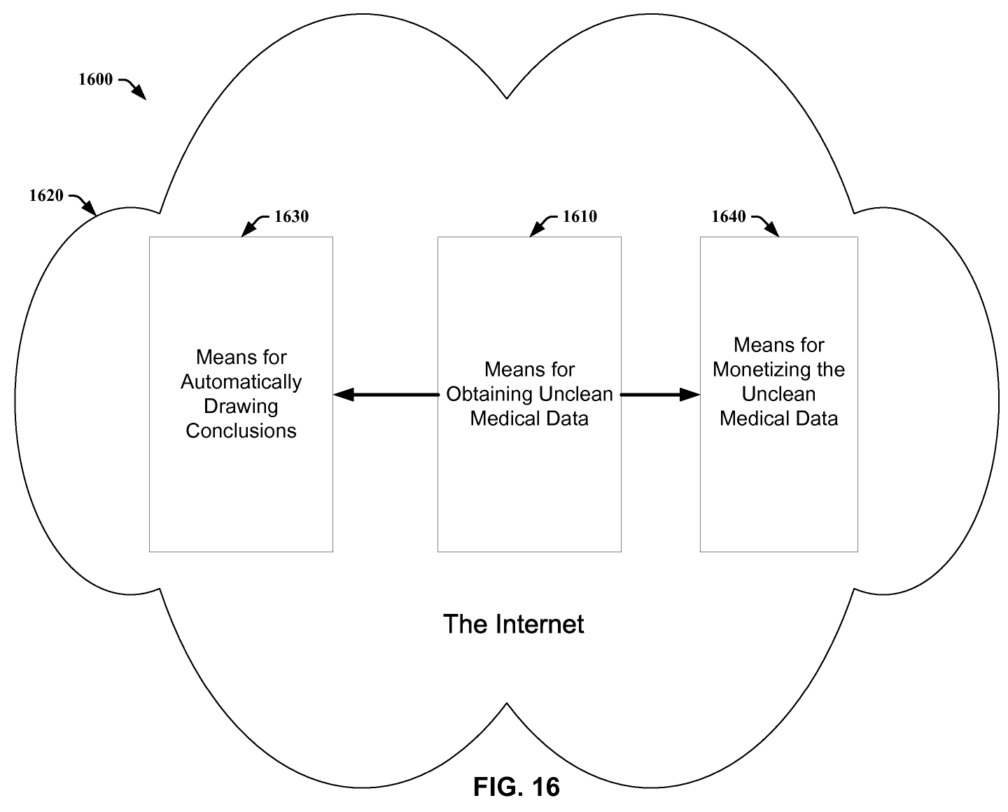

FIG. 16 is a block diagram of one example of an online system 1600 to facilitate monetizing unclean medical data. The system 1600 includes a means for obtaining unclean medical data 1610 from an unselected population via the Internet 1620. The unclean medical data is used by the means for automatically drawing conclusions 1630 to draw conclusions. Examples of the types of conclusions that can be drawn are described in relation to the figures above. The means for automatically drawing conclusions 1630 can employ, for instance, one or more of a statistical algorithm, a machine-learning algorithm, a data-mining algorithm and an artificial-intelligence algorithm to draw conclusions.

The system 1600 also includes a means for monetizing 1640 the unclean medical data. Examples of monetizing unclean data are given in the description of the figures above. For instance, the means for monetizing 1640 the unclean medical data can deliver an advertisement to one or more of the unselected population in response to a medical query and can choose the advertisement based on the content of the medical query (e.g., dynamic advertisement delivery). The advertiser can be charged a fee for the delivery of the advertisement. The advertisement can be chosen based on any suitable method including but not limited to holding a keyword/phrase auction and presenting the highest bidder's ad if the medical query includes the keyword/phrase or the keyword/phrase is inferred from the medical query. The means 1610, 1630 and 1640 of the system 1600 include but are not limited to the structures and algorithms described above in relation to FIGS. 1-15.

As used in this application, the term “means” is intended to refer to a computer-related entity, either hardware, a combination of hardware and software, software, or software in execution. For example, a means can be, but is not limited to being, a process running on a processor, a processor, an object, an executable, a thread of execution, a program, and/or a computer. By way of illustration, both an application running on a server and the server can be a means. One or more means can reside within a process and/or thread of execution and a means can be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the user interfaces, methods and systems described herein can be practiced with all computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The user interfaces, methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

In regard to the various functions performed by the above described components, computer-executable instructions, means, systems and the like, the terms are intended to correspond, unless otherwise indicated, to any functional equivalents even though the functional equivalents are not structurally equivalent to the disclosed structures. Furthermore, to the extent that the terms “includes,” and “including” and variants thereof are used in either the specification or the claims, these terms are intended to be inclusive in a manner similar to the term “comprising.” Accordingly, the claimed subject matter is intended to embrace all such alterations, modifications, and variations that fall within the spirit and scope of the appended claims.

What is claimed is:

1. A system that facilitates monitoring a database of unclean health-related data collected on a large-scale, comprising:
a data collection component to collect the unclean health-related data on a large-scale, the unclean health-related data pertaining to a non-selected population;
the database to store at least some of the unclean health-related data;
an aggregation component to facilitate automatically ascertaining at least one pattern from the unclean health-related data, the aggregation component automatically ascertaining the at least one pattern from the unclean health-related data at least in part by applying a statistical technique, a data mining technique and/or a machine-learning technique to the database; and
a tracking component to monitor a third party use of the database.

2. The system of claim 1, wherein the tracking component further determines a fee to be charged for the third party use of the database.

3. The system of claim 2, wherein the third party use of the database comprises an inquiry from a member of the non-selected population.

4. The system of claim 3, wherein the inquiry relates to the member's health and/or wellness.

5. The system of claim 4, further comprising an information delivery component to provide the member with information relating to the inquiry.

6. The system of claim 5, wherein the information is a diagnosis and/or a health provider appointment.

7. The system of claim 6, wherein the information is a health provider appointment and the fee is a referral fee.

8. The system of claim 1, wherein the third party is a member of the non-selected population and the tracking component further provides an advertisement to the member.

9. The system of claim 8, wherein the tracking component further determines a fee to be charged to an entity placing the advertisement.

10. The system of claim 9, wherein the third party use of the database is an inquiry placed by the member and the advertisement is based on the inquiry.

11. A method of monetizing information obtained on a macro-scale, comprising:
receiving information about a plurality of self-selected subjects;
aggregating at least some of the information;
mining the aggregated information at least in part by employing a statistical algorithm, a data-mining algorithm and/or a machine-learning algorithm to infer one or more health observations from the aggregated information; and
monetizing the aggregated information.

12. The method of claim 11, further comprising providing at least some of the plurality of self-selected subjects with at least one incentive to self-select to supply information.

13. The method of claim 11, wherein monetizing the aggregated information comprises determining advertising fees and/or determining information retrieval fees.

14. The method of claim 11 , further comprising:
receiving a request from one of the plurality of self-selected subjects; and
providing the one of the plurality of self-selected subjects with information pertaining to the request.

15. The method of claim 14, wherein monetizing the aggregated information comprises delivering an advertisement to the one of the plurality of self-selected subjects.

16. The method of claim 14, wherein providing the one of the plurality of self-selected subjects with information pertaining to the request comprises providing the one of the plurality of self-selected subjects with information about one or more health-care entities and wherein monetizing the aggregated information comprises sending an invoice to the one or more health-care entities.

17. The method of claim 14, wherein monetizing the aggregated information comprises charging the one of the plurality of self-selected subjects for receiving the information pertaining to the request.

18. An online system to facilitate monetizing unclean medical data, comprising:
means for obtaining unclean medical data from an unselected population via the Internet;
means for automatically drawing conclusions from the unclean medical data, the means for automatically drawing conclusions from the unclean medical data employing a statistical algorithm, a machine-learning algorithm, a data-mining algorithm and/or an artificial-intelligence algorithm to draw at least one conclusion from the unclean medical data; and
means for monetizing the unclean medical data.

19. The system of claim 18, wherein the means for monetizing the unclean medical data delivers an advertisement to one or more of the unselected population in response to the one or more of the unselected population inputting a medical query.

20. The system of claim 19, wherein the means for monetizing the unclean medical data chooses the advertisement based on the medical query content.
